(19) United States
(12) Patent Application Publication
(10) Pub. No.: US 2025/0286096 A1
(43) Pub. Date: Sep. 11, 2025

(54) MEMBRANE ELECTRODE ASSEMBLY HAVING AN ORGANIC SOLVENT

(71) Applicant: GM Global Technology Operations LLC, Detroit, MI (US)

(72) Inventors: Nagappan Ramaswamy, Rochester Hills, MI (US); Swaminatha P. Kumaraguru, Rochester Hills, MI (US)

(73) Assignee: GM Global Technology Operations LLC, Detroit, MI (US)

(21) Appl. No.: 18/599,515

(22) Filed: Mar. 8, 2024

(51) Int. Cl. H01M 8/1039; C25B 9/23; C25B 13/08; H01M 8/10; H01M 8/1004

(52) U.S. Cl. CPC H01M 8/1039; C25B 9/23; C25B 13/08; H01M 8/1004; H01M 2008/1095; H01M 2250/20; H01M 2300/0082

(57) ABSTRACT

A membrane electrode assembly includes a cathode electrode disposed on one end and including a positively charged porous electrode and an anode electrode disposed on an opposite end from the cathode and including a negatively charged porous electrode. The membrane electrode assembly also includes a proton exchange membrane disposed between the cathode and the anode. The cathode and/or anode electrodes further includes a catalyst active material, carbon support molecules, at least one ionomer, and one or more hydrofluoroethers.

### GOVERNMENT FUNDING

This invention was made with Government support under Contract No. DE-EE0008821 awarded by the United States Department of Energy (DOE), Hydrogen and Fuel Cell Technologies Office (HFTO). The Government may have certain rights in the invention.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a membrane electrode assembly and more particularly to a membrane electrode assembly including an organic solvent disposed therein.

Fuel cells are a clean energy source such that, when fueled with pure hydrogen and air as an oxidant, the only by-products are heat and water, making fuel cells a sustainable power source.

Fuel cells include a membrane electrode assembly having a cathode electrode and an anode electrode opposing one another with a proton exchange membrane disposed between the two electrodes. The cathode electrode and the anode electrode are configured to be layered with supported nanoparticle catalysts that accelerate chemical reactions inside the fuel cell. The nanoparticle catalysts include precious metals such as platinum and are supported on carbon black. Moreover, ionomers, which act as a proton conducting agent and a binder to hold the supported nanoparticles together, are dispersed on the supported nanoparticles. Generally, the ratio of ionomer to carbon by weight is approximately 1.0 for the cathode electrode. Nevertheless, excessive ionomer use leads to undesirable sulfonic acid poisoning and overall fuel cell inefficiencies. As such, a fuel cell membrane electrode assembly with a lower ionomer-to-carbon ratio in the electrodes is desired.

### SUMMARY

In one configuration, a membrane electrode assembly includes a cathode electrode disposed on one end and an anode electrode disposed on the opposite end from the cathode. Additionally, the cathode includes at least one catalyst layer including an active material, carbon support, at least one ionomer, and one or more hydrofluoroethers. Moreover, the membrane electrode assembly also includes a proton exchange membrane disposed between the cathode electrode and the anode electrode.

The membrane electrode assembly may also include one or more of the following optional features. For example, the ionomer may be perfluorosulfonic acid. Additionally, a weight ratio of carbon to ionomer within the catalyst layer may be about 0.2 to about 0.8. Moreover, a weight ratio of carbon to ionomer within the catalyst layer may be about 0.4 to about 0.6. Additionally, a weight ratio of carbon to ionomer within the catalyst layer may be about 0.5. Moreover, the hydrofluoroether may be methyl nonafluorobutyl ether, or methyl nonafluoroisobutyl ether, or methyl perfluoropropyl ether. Further, a fuel cell may incorporate the membrane electrode assembly and is configured to produce electricity. Additional, an electric vehicle may incorporate a fuel cell device to power the vehicle.

In another configuration, a membrane electrode assembly includes a cathode disposed on one end and an anode disposed on an opposite end from the cathode. Additionally, the cathode includes at least one catalyst layer which includes a plurality of active catalysts materials and an organic solvent. Moreover, the membrane electrode assembly also includes a proton exchange membrane disposed between the cathode and the anode. Additionally, the organic solvent is configured to decrease the amount of catalyst material degradation within the catalyst layer by at least 40% compared to a catalyst layer without the organic solvent and without sacrificing performance of the membrane electrode assembly.

The membrane electrode assembly may also include one or more of the following optional features. For example, the catalyst layer may be comprised of carbon supported nanoparticles dispersed with perfluorosulfonic acid ionomer binder. Additionally, a weight ratio of carbon to ionomer within the catalyst layer may be about 0.2 to about 0.8. Moreover, a weight ratio of carbon to ionomer within the catalyst layer may be about 0.4 to about 0.6. Additionally, a weight ratio of carbon to ionomer within the catalyst layer may be about 0.5. Further, the organic solvent may be a hydrofluoroethers. Additionally, the organic solvent may be methyl nonafluorobutyl ether, methyl nonafluoroisobutyl ether, or methyl perfluoropropyl ether. Further, a fuel cell may incorporate the membrane electrode assembly and is configured to produce electricity, using hydrogen as fuel. Additionally, an electric vehicle may incorporate the fuel cell to power the vehicle.

In another configuration, a membrane electrode assembly includes at least one catalyst layer. The catalyst layer includes a plurality of catalyst active materials and a hydrofluoroether compound such as methyl nonafluorobutyl ether, methyl nonafluoroisobutyl ether, and methyl perfluoropropyl ether. Additionally, the hydrofluoroether compound is configured to decrease a surface tension of the catalyst layer compared to a catalyst layer which does not include the hydrofluoroether and is configured to decrease the amount of catalyst degradation within the catalyst layer by at least 40% without sacrificing performance.

The membrane electrode assembly may also include one or more of the following optional features. For example, the catalyst layer may be comprised of carbon supported catalyst nanoparticles dispersed with perfluorosulfonic acid ionomer binder. Additionally, a ratio of carbon to ionomer within the catalyst layer nay be about 0.2-0.8. Further, a ratio of carbon to ionomer within the catalyst layer may be about 0.4-0.6.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a fuel cell having a membrane electrode assembly according to the present disclosure;

FIG. 2 is a schematic view of a fuel cell having the membrane electrode assembly according to the present disclosure;

FIG. 3 is a schematic view of ionomers disposed within a cathode of the membrane electrode assembly according to the present disclosure;

FIG. 4A is a graphical representation illustrating Cathode Mass Activity of various membrane electrode assemblies which include an organic solvent and varying Ionomer-to-Carbon ratios;

FIG. 4B is a graphical representation illustrating Cell Voltage of various membrane electrode assemblies which include the organic solvent and varying Ionomer-to-Carbon ratios; and

FIG. 4C is another graphical representation illustrating Cell Voltage of various membrane electrode assemblies which include the organic solvent and varying Ionomer-to-Carbon ratios.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

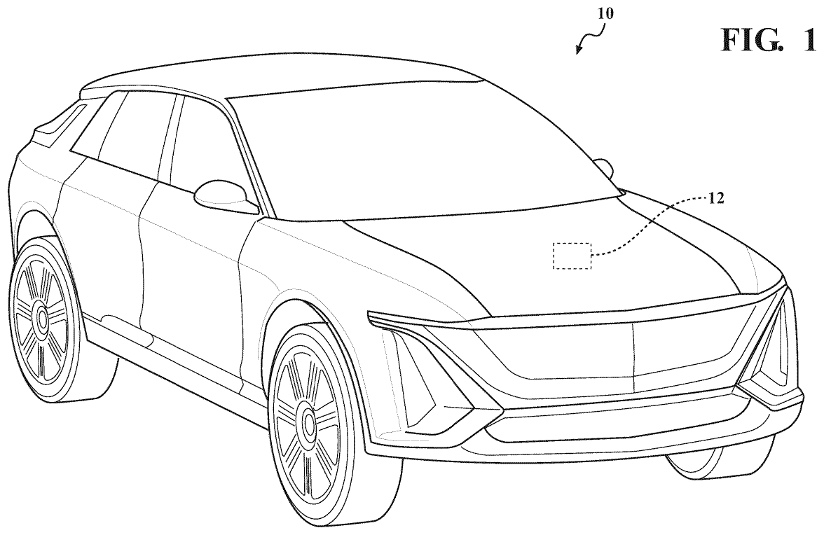

Referring to FIGS. 1-4C, a fuel cell 12 is disclosed. The fuel cell 12 is configured to use hydrogen as fuel and air as an oxidant to generate electricity. Additionally, the fuel cell 12 may be incorporated into devices that require energy such as an appliance or a vehicle 10, as shown in FIG. 1. When the fuel cell 12 is incorporated into the vehicle 10, the vehicle 10 maybe an electric vehicle 10 (EV) and may include autonomous or semi-autonomous capabilities. Alternatively, the vehicle 10 may be a hybrid vehicle 10 incorporating both EV and internal combustion engine (ICE) components and capabilities. The vehicle 10 also includes the fuel cell 12 configured to provide power to the vehicle 10. More specifically, vehicles 10 including the fuel cell 12 are powered by compressed hydrogen gas that feeds into an onboard fuel cell stack that doesn't burn the gas, but instead transforms the fuel's chemical energy into electrical energy to power an electric motor to power the vehicle 10. Additionally, the fuel cell 12 may be used in stationary applications as a clean energy substitute for diesel generators to provide an uninterrupted power supply. Moreover, fuel cells may also be connected to an electric grid to provide supplemental power.

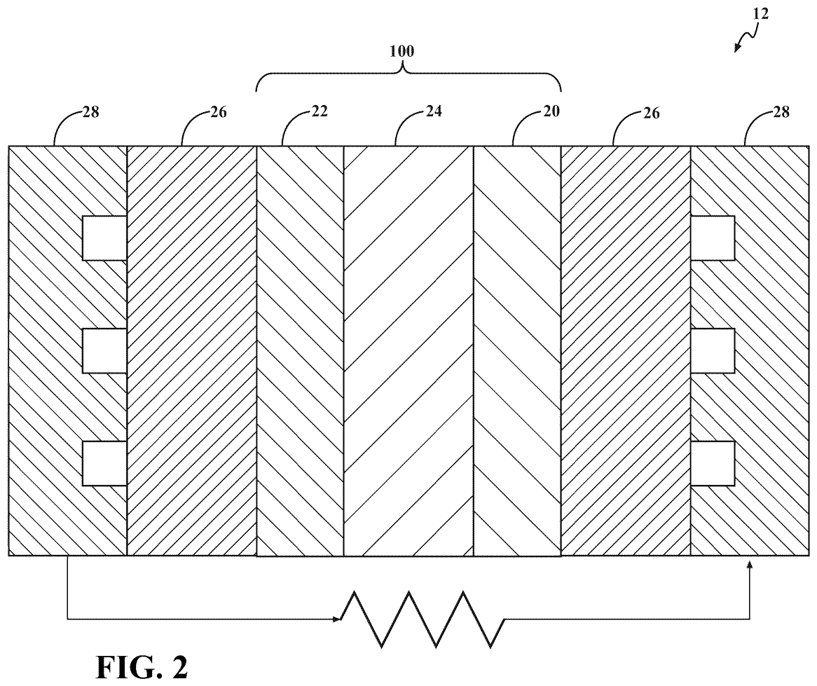

As best shown in FIG. 2, the membrane electrode assembly 100 includes a cathode catalyst layer 20 disposed on one end and an anode catalyst layer 22 disposed on an opposite end from the cathode catalyst layer 20. The cathode catalyst layer 20 includes a positively charged porous electrode by which electrons enter the membrane electrode assembly 100 and within which oxygen reduction reaction occurs (i.e., a chemical reaction that yields water). Additionally, the anode 22 includes a negatively charged porous electrode within which the hydrogen oxidation reaction occurs to generate protons and electrons with the electrons leaving the membrane electrode assembly 100. Gas flow into the cathode catalyst layer 20 and the anode catalyst layer 22 and water removal from the membrane electrode assembly 100 is facilitated by a gas diffusion layer 26 and flow fields in a bipolar plate assembly 28.

Referring still to the example shown in FIG. 2, the proton exchange membrane 24 is disposed between the cathode catalyst layer 20 and the anode catalyst layer 22. Generally, the proton exchange membrane 24 may be comprised of a fluoropolymer proton permeable electrical insulator barrier. Alternatively, the proton exchange membrane 24 may be a hydrocarbon proton permeable electrical insulator barrier. Further, the proton exchange membrane 24 serves as a conductor for protons generated at the anode 22 to transport to the cathode catalyst layer 20 to combine with oxygen and electrons to produce water and electricity.

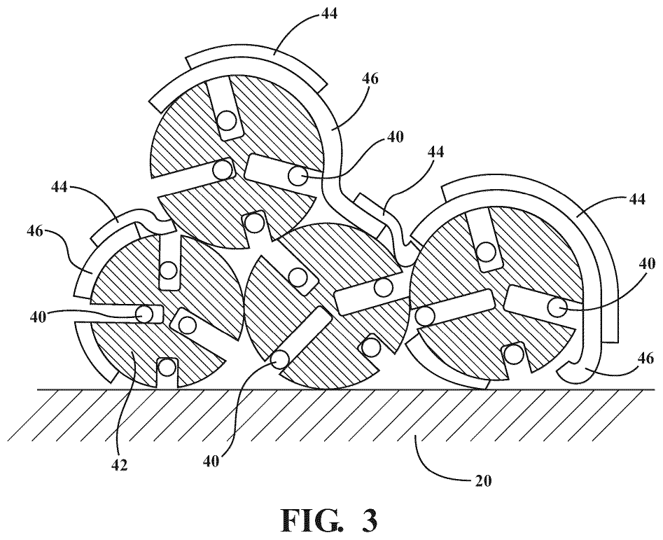

As best shown in FIG. 3, the cathode catalyst layer 20 includes at least a catalyst active material 40, support molecules 42, and an ionomer 44. The catalyst active material 40 is configured to recombine stoichiometric amounts of protons and oxygen gas and convert them into water, which then condenses and replenishes the fuel cell 12. Additionally, the catalyst active material 40 may be supported nanoparticles. Further, the catalyst active materials 40 may include, but are not limited to, nanoparticles of Platinum, Palladium, Copper, Gold, Ruthenium, Silver, Cobalt, Iridium, and/or Nickel. Additionally, the catalyst active material 40 may be in powder or another form.

As best shown in FIG. 3, due to their size, the catalyst active material 40 may be supported within the catalyst layer 20. More specifically, the catalyst active material 40 may be supported by a support molecule 42. Additionally, the support molecule 42 may be one or more of carbon, an oxide, charcoal, or a zeolite. Further, the support molecules 42 may include, but are not limited to, carbon black, one-dimensional forms of carbon, any allotropes of carbon, and/or metal oxides.

Additionally, the ionomer 44 acts both as a proton conducting agent and a binder to hold the supported catalyst active material 40 together on the electrode of the cathode 20. More specifically, the ionomer 44 may consist of repeating units of electrically neutral and ionized groups bonded to a polymer backbone. For example, the ionomer 44 may be perfluorosulfonic acid or other perfluorinated and/or polyfluorinated alkyl compounds. However, excess ionomers 44 within the catalyst layer 20 can lead to sulfonate anion poisoning and oxygen gas transport resistance due to ionomer 44 usage and leads to decreased cathode mass activity and performance of the cathode catalyst layer 20. This causes fuel cell 12 inefficiency and degradation of the proton exchange membrane fuel cell 24 over the lifetime of the fuel cell 12.

To reduce sulfonate anion poisoning and oxygen gas transport resistance within the fuel cell 12, the cathode catalyst layer 20 includes an organic solvent 46 configured to decrease the surface tension of the support molecule 42. More specifically, the supported catalyst active material 40, typically in its powder form, may be treated with organic solvent 46 which has a low surface tension to improve ionomer 44 dispersion on the support molecule 42 once combined. Further, the low surface tension of the organic solvent 46 enables an enhanced adsorption of ionomer 44 on the surface of the supported catalyst active material 40 and a more homogeneous distribution of the supported catalyst active material 40 of the cathode catalyst layer 20. Additionally, the organic solvent 46 may include, but is not limited to, one or more ethers, such as a hydrofluoroether. Moreover, the hydrofluoroether may include, but is not limited to, methyl nonafluorobutyl ether, methyl nonafluoroisobutyl ether, or methyl perfluoropropyl ether.

Additionally, the enhanced adsorption of ionomer 44 on the surface of the supported catalyst active material 40 when the catalyst nanoparticle 40 and support 42 is combined with the organic solvent 46 allows the use of lower ionomer 44 amounts compared to the state-of-the-art cathode catalyst layers 20, without compromising on the performance of the fuel cell 12. More specifically, the organic solvent 46 is configured to decrease the amount of ionomers 44 within the cathode catalyst layer 20 by at least 10% compared to a catalyst layer without the organic solvent 46 and without sacrificing performance of the membrane electrode assembly 100. In another example, the organic solvent 46 is configured to decrease the amount of ionomers 44 within the cathode catalyst layer 20 by at least 20% compared to a catalyst layer without the organic solvent 46 and without sacrificing performance of the membrane electrode assembly 100. In another example, the organic solvent 46 is configured to decrease the amount of ionomers 44 within the cathode catalyst layer 20 by at least 30% compared to a catalyst layer without the organic solvent 46 and without sacrificing performance of the membrane electrode assembly 100. In another example, the organic solvent 46 is configured to decrease the amount of ionomers 44 within the catalyst layer 20 by at least 40% compared to the catalyst layer without the organic solvent 46 and without sacrificing performance of the membrane electrode assembly 100. In yet another example, the organic solvent 46 is configured to decrease the amount of ionomers 44 within the catalyst layer 20 by at least 50% compared to the catalyst layer without the organic solvent 46 and without sacrificing performance of the membrane electrode assembly 100.

More specifically, when the support molecule 42 is carbon and with the organic solvent 46 in the cathode catalyst layer 20, a weight ratio of carbon to ionomer 44 within the catalyst layer 20 is about 0.2 to about 0.8. In another example, when the support molecule 42 is carbon and with the organic solvent in the catalyst layer, the weight ratio of carbon to ionomer 44 within the catalyst layer 20 is about 0.4 to about 0.6. In yet another example, when the support molecule 42 is carbon and with the organic solvent in the catalyst layer, the weight ratio of carbon to ionomer 44 within the catalyst layer 20 is about 0.5.

Additionally, the catalyst layer 20 herein may include about 5% to about 3% weight percent ionomer (in other approaches, about 9% to about 18% weight percent ionomer, and in yet further approaches, about 12% to about 15% weight percent ionomer); about 15% to about 30% weight percent carbon (in other approaches, about 18% to about 28% weight percent carbon, and in yet further approaches, about 21% to about 25% weight percent carbon); about 10% to about 70% weight percent catalyst active material (in other approaches, about 20% to about 60% weight percent gas recombination catalyst, and in yet further approaches, about 30% to about 50% weight percent gas recombination catalyst); and about 0.5% to about 10% weight percent organic solvent such as hydrofluoroether (in other approaches, about 1% to about 5% weight percent organic solvent such as hydrofluoroether, and in yet further approaches, about 1.5% to about 3% weight percent organic solvent such as hydrofluoroether).

### EXAMPLE

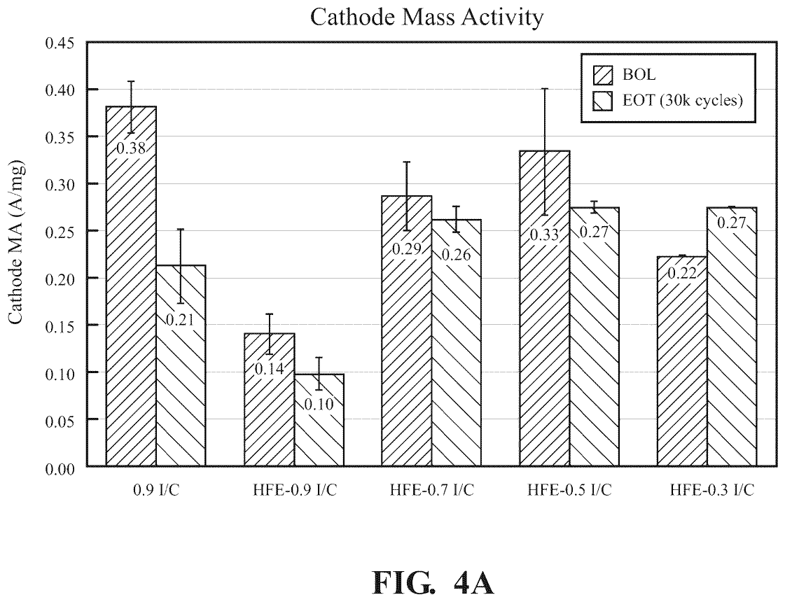

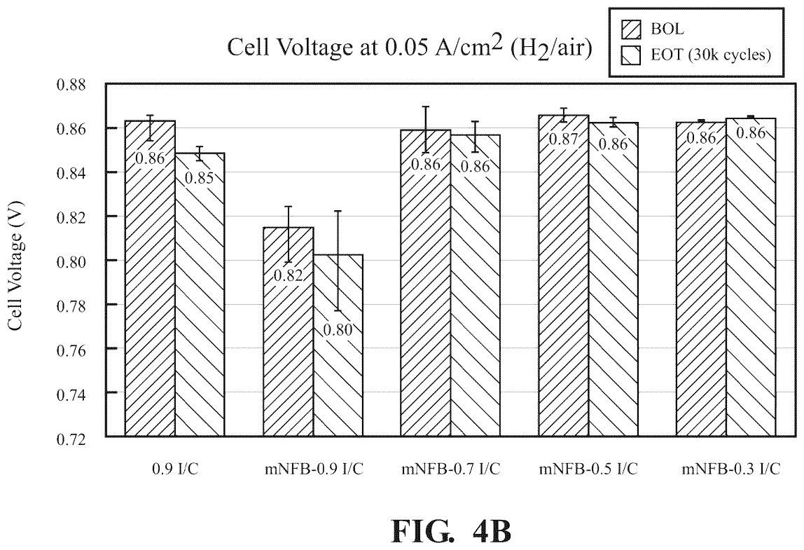

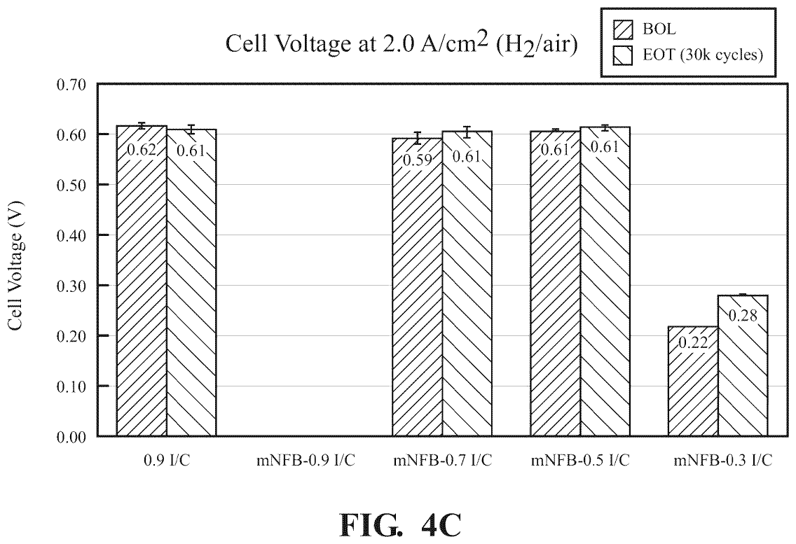

Referring now to the examples shown in FIGS. 4A-4C, catalyst active material 40, in powder form, was mixed with low surface tension fluorocarbon molecules such as methoxynonafluorobutane. More specifically, in the example shown, approximately 5 grams of the catalyst active material 40 powder was mixed with 95 grams of methoxy-nonafluorobutane in a 250 ml high-density polyethylene container to formulate the dispersion. Additionally, Zirconia beads were used to roll-mill the dispersion. More specifically, Zirconia beads to catalyst active material 40 dispersion with a weight ratio of 4 to 1 was utilized and the dispersion was roll-milled for 16 hours. After that, the dispersion was vacuum filtered and dried in an oven in a nitrogen gas environment at 100 degrees Celsius for 15 minutes. The dried catalyst powder was collected as the final desired product.

As shown in FIGS. 4A-4C the resulting fuel cell 12 enables lower ionomer usage due to the presence of the low surface tension molecules. More specifically, FIG. 4A illustrates improved cathode mass activity of the fuel cell with hydrofluoroether treated catalyst nanoparticles 40 supported on support molecules 42 leading to higher efficiency of the fuel cell 12. Additionally, FIGS. 4B and 4C illustrate similar fuel cell performance of the fuel cell 12 with hydrofluoroether treated catalysts compared to a fuel cell which does not include the hydrofluoroether at fuel cell voltages of both 0.05 A/cm² and 2.0 A/cm². While a typical ionomer-to-carbon (I/C) ratio of a non-modified baseline catalyst is about 0.9 I/C, the presence of the fluorocarbon modification enables the use of lower ionomer-to-carbon ratio with the optimal I/C of a fluorocarbon modified catalyst being about 0.5 I/C.

Applying the organic solvent 46 to the supported catalyst nanoparticles 40 leads to a supported catalyst nanoparticle 40 surface with very low surface tension that enables an enhanced adsorption of perflurosulfonic acid ionomer 44 on the surface. This leads to the use of lower ionomer 44 contents by approximately 50% compared to the state-of-the-art cathode catalyst layers, without compromising performance. Further, this enables lower sulfonate anion poisoning due to a decrease in ionomer 44 usage and leads to improved mass activity retention of the cathode catalyst layer 20. As such, the fuel cell 12 efficiency is increased over the lifetime by enabling better mass activity retention of the supported catalysts 40.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A membrane electrode assembly comprising:
a cathode electrode disposed on one end;
an anode electrode disposed on an opposite end from the cathode electrode; and
a proton exchange membrane disposed between the cathode electrode and the anode electrode,
wherein the cathode electrode further includes at least one catalyst layer including a catalyst active material, carbon support molecules, at least one ionomer, and one or more hydrofluoroethers.

2. The membrane electrode assembly of claim 1, wherein the ionomer is perfluorosulfonic acid.

3. The membrane electrode assembly of claim 2, wherein a weight ratio of carbon to ionomer within the catalyst layer is about 0.2 to about 0.8.

4. The membrane electrode assembly of claim 2, wherein a weight ratio of carbon to ionomer within the catalyst layer is about 0.4 to about 0.6.

5. The membrane electrode assembly of claim 2, wherein a weight ratio of carbon to ionomer within the catalyst layer is about 0.5.

6. The membrane electrode assembly of claim 2, wherein the hydrofluoroether is methyl nonafluorobutyl ether, methyl nonafluoroisobutyl ether, or methyl perfluoropropyl ether.

7. An fuel cell incorporating the membrane electrode assembly of claim 1 and configured to produce electric power.

8. A vehicle incorporating the fuel cell of claim 7 to generate electricity to power the vehicle.

9. A membrane electrode assembly comprising:
a cathode electrode disposed on one end of the membrane electrode assembly and including:
at least one catalyst layer including:
a plurality of catalyst active material; and
an organic solvent;
an anode electrode disposed on an opposite end of the membrane electrode assembly from the cathode electrode and including:
at least one catalyst layer including:
a plurality of catalyst active material; and
an organic solvent; and
a proton exchange membrane disposed between the cathode electrode and the anode electrode,
wherein the organic solvent is configured to decrease the amount of catalyst active material degradation within the catalyst layer by at least 40% compared to a catalyst layer without the organic solvent and without sacrificing performance of the membrane electrode assembly.

10. The membrane electrode assembly of claim 9, wherein the catalyst layer is comprised of carbon supported nanoparticles dispersed with perfluorosulfonic acid ionomer binder.

11. The membrane electrode assembly of claim 10, wherein a weight ratio of carbon to ionomer within the catalyst layer is about 0.2 to about 0.8.

12. The membrane electrode assembly of claim 10, wherein a weight ratio of carbon to ionomer within the catalyst layer is about 0.4 to about 0.6.

13. The membrane electrode assembly of claim 10, wherein a weight ratio of carbon to ionomer within the catalyst layer is about 0.5.

14. The membrane electrode assembly of claim 9, wherein the organic solvent is hydrofluoroethers.

15. The membrane electrode assembly of claim 9, wherein the organic solvent is a hydrofluoroether including one or more of methyl nonafluorobutyl ether, methyl nonafluoroisobutyl ether, or methyl perfluoropropyl ether.

16. An electrolyzer incorporating the membrane electrode assembly of claim 9.

17. A membrane electrode assembly comprising:
at least one catalyst layer including:
a plurality of catalyst active material; and
a hydrofluoroether, wherein the hydrofluoroether is configured to decrease a surface tension of the catalyst layer compared to a catalyst layer which does not include the hydrofluoroether and configured to decrease the degradation amount of catalyst active material within the catalyst layer by at least 40% without sacrificing performance.

18. The membrane electrode assembly of claim 17, wherein the catalyst layer is comprised of carbon supported nanoparticles dispersed with perfluorosulfonic acid ionomer binder.

19. The membrane electrode assembly of claim 18, wherein a ratio of carbon to ionomer within the catalyst layer is about 0.2 to about 0.8.

20. The membrane electrode assembly of claim 18, wherein a ratio of carbon to ionomer within the catalyst layer is about 0.4 to about 0.6.
